(19) United States
(12) Patent Application Publication
(10) Pub. No.: US 2014/0258987 A1
(43) Pub. Date: Sep. 11, 2014

(54) DETERMINING CORRECTNESS OF AN APPLICATION

(71) Applicant: EMC Corporation, Hopkinton, MA (US)

(72) Inventors: Baoyao Zhou, Beijing (CN); Tao Chen, Beijing (CN); Tianqing Wang, Shanghai (CN); Jun Tao, Shanghai (CN); Dong Xiang, Shanghai (CN); Yu Cao, Beijing (CN)

(73) Assignee: EMC Corporation, Hopkinton, MA (US)

(21) Appl. No.: 14/198,019

(22) Filed: Mar. 5, 2014

(30) Foreign Application Priority Data
Mar. 8, 2013 (CN) 201310086342.5

(51) Int. Cl. G06F 11/36

(52) U.S. Cl. CPC G06F 11/3692
USPC 717/126

(57) ABSTRACT

The present invention provides a method for determining correctness of an application, comprising: obtaining a dataset and a reference running result for the application; and determining correctness of the application based on a comparison between the reference running result and an actual running result of the dataset on the application. Through the method, the users can connect to a standard task tool repository, thereby using a data-driven testing method as a complement to the existing quality assurance framework.

### RELATED APPLICATION

This application claims priority from Chinese Patent Application Serial No. CN201310086342.5 filed on Mar. 8, 2013 entitled “Method and System for Determining Correctness of an Application,” the content and teachings of which are hereby incorporated by reference in their entirety.

### TECHNICAL FIELD

Embodiments of the present invention generally relate to the field of information technology, and more specifically, to a method and system for determining correctness of an application with application to quality assurance.

### BACKGROUND

Data mining (DM), also referred to as knowledge discovery in database (KDD), is a relatively intense field of research in areas of artificial intelligence and databases. Data mining refers to a non-trivial process of discovering implicit, previously unknown and potentially useful information from mass data available in databases, which may be in structured or unstructured form.

With the constant development of data mining technology, various applications related to big data analytics are surfacing one after another. Big data analytics provides data mining technology with abilities based on classification/clustering analytics, streaming data mining and text mining to name a few. Therefore, providing quality assurance for various applications related to big data analytics becomes a key technique to promote data mining technology.

For enterprise-level products/applications, the quality of products/applications may be assured by function test and unit test. A usual way is that users first design some (input, output) pairs for the functions or code blocks to be tested, subsequently run a program, and finally validate the consistence of the actual output to the expected output. However, this process may not be suitable for testing the quality (correctness) of complex applications in big data analytics, specifically when such applications relate to using randomized methods. This typically happens because while feeding certain types of inputs to the algorithm, there is no deterministic output, but many possible, innumerable approximate outputs. Users now face the problems of including (1) how to generate big testing data; (2) how to define/compute expected output; and (3) how to measure/define success of the output.

### SUMMARY

To solve some the above problems in the prior art, embodiments of the present invention proposes a method, apparatus and computer program product for determining correctness of an application by obtaining a dataset and a reference running result for the application; and determining correctness of the application based on a comparison/mapping between the reference running result and an actual running result of the dataset on the application.

In an optional implementation of the present disclosure, the reference running result comprises a running result of the dataset on another application that is aimed at potentially solving/addressing the same problem as the application.

In an optional implementation of the present disclosure, the dataset comprises a real dataset.

In an optional implementation of the present disclosure, the dataset and the reference running result are obtained from a public platform.

In an optional implementation of the present disclosure, the application comprises a randomness-related application.

In an optional implementation of the present disclosure, the comparison is output in a graphical form.

By means of the above various implementations of the present disclosure, it is possible to evaluate model performance such as classification accuracy and the like for some data mining tasks. Further, the quality of an application may be assured by comparing execution performance of the application with execution performance of other proven implementation on publically published, available datasets.

### BRIEF DESCRIPTION OF THE SEVERAL VIEWS OF THE DRAWINGS

Through the more detailed description in the accompanying drawings, the above and other objects, features and advantages of the embodiments of the present invention will become more apparent. Several embodiments of the present invention are illustrated schematically and are not intended to limit the present invention in the drawing, where like reference numerals denote the same or similar elements through the figures.

FIG. 1 shows an example of an application related to a randomized method;

FIG. 2 shows a flowchart of a method 200 for determining correctness of an application according to an exemplary embodiment of the present invention;

FIG. 3 shows a schematic view 300 of a system for determining correctness of an application based on Standard Task Pool according to an exemplary embodiment of the present invention;

FIG. 4 shows a diagram of an apparatus 400 for determining correctness of an application according to an exemplary embodiment of the present invention; and

FIG. 5 shows a block diagram of an exemplary computer system 500 which is applicable to implement the embodiments of the present invention.

### DETAILED DESCRIPTION

Principles and spirit of the present disclosure will be described with reference to some exemplary embodiments that are shown in the accompanying drawings. It is to be understood that these embodiments are provided only for enabling those skilled in the art to better understand and further implement the present disclosure, rather than limiting the scope of the present invention in any fashion.

As described above, big data analytics is the process of turning data that is available on a massive scale into actionable insights. This is different from traditional business intelligence such as OLAP, which is only concerned with ad-hoc sql and reporting. However, big data analytics stands for deep analytics using complex data mining methods. The complexity of these methods may originate from several sources, among which randomness is a very particular instance. Randomized methods have the property that even for a fixed input, different runs of a randomized algorithm may give different outputs. To assure correctness of a technical application related to big data analytics, it becomes therefore essential to assure the correctness of a randomized algorithm involved in the application.

Roughly randomized methods (such as without limitation to algorithms) may include categories such as: sampling-based methods, such as MCMC (Markov Chain Monte Carlo) algorithms and LDA (Latent Dirichlet Allocation) algorithms; streaming DM methods, such as sliding window algorithms; optimization methods, such as EM algorithms and genetic algorithms; and ensemble learning methods, such as random forest algorithms and bagging algorithms.

As described above, due to the randomness of these methods, it becomes relatively difficult to assure quality of these algorithms being used. While testing traditional software systems in terms of their feature and performance, Users usually generate test cases in the form of (input, output), where the output is the expected output for a given input. The system is claimed to pass one test case if the actual output for a given input is identical to the expected output. Considering some of the randomized data mining methods, the following problems may typically arise:

First, it becomes difficult to find some big data sets for determining correctness of the methods. In order to test some method, it is necessary to generate/find datasets. Manually generated big datasets are time-consuming and sometimes too regular, defeating the randomness property. And, real big datasets are generally difficult to obtain.

Second, it is sometimes difficult to define the expected output. Consider an application related to the random forecast algorithm as an example (to be described in detail below). The output of the random forecast algorithm is a number of (say 100) decision trees. The trees in one run are different; and each run will be different from the other run due to the randomness factor. Therefore the user cannot predict an expected output in advance.

Third, it is unlikely or in all probability that the actual output is the same as the pre-defined expected output. Therefore it becomes difficult to define/measure the success of a test. Consider the Expectation-Maximization algorithm (EM algorithm) as an example. EM is used to pursue the maximum likelihood estimation (MLE) for some probabilistic models given the observed data. It is a hill-climbing-like algorithm which is likely to get trapped into local maxima. In other words, there is more than one valid output. So the user cannot claim that the algorithm has failed in a test case even though the actual output is not identical to the expected output.

In fact, there exist a variety of randomized methods that can be used in data mining. For example, K-Means and EM algorithms randomly select initial starting points in order to alleviate the problem of local maxima; Genetic algorithms start from a population of randomly generated individuals, and then generates the next generation by modifying (recombining or randomly mutating) the individuals in the current generation; in the training process of LDA, a sampling-based method is usually used where the values are randomly generated according to some kind of distribution or a known distribution.

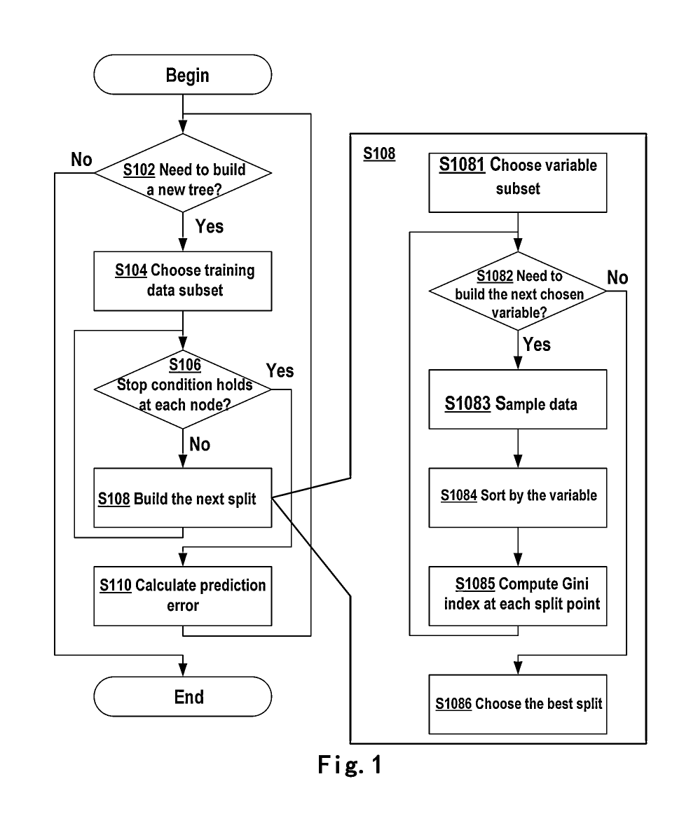

Such applications are illustrated by for example by considering the random forest algorithm. Random forest is an ensemble model consisting of a bunch or group of decision trees. An application example related to the random forest is shown in FIG. 1. After the random forest method (algorithm) begins, for each tree to be constructed (step S102), a training data subset is chosen (i.e. Bootstrap sampling, step S104). When a stop condition holds each node (step S106, Yes), a prediction error is calculated; when the stop condition does not hold (step S106, No), the next split/fragment is built (step S108). Specifically, the process of building the next split (step S108) may comprise steps like S1081 to S1086 such as choosing a variable subset (i.e. subspace sampling). In addition, the tree is used to predict a category of remaining data and evaluate errors.

It can be seen that the random forest method involves randomness in step S104 (bootstrap sampling) and step S1081 (subspace sampling): the bootstrap sampling is used to generate different bootstrap samples from the original training data, while in the decision tree learning process, the subspace sampling uses several random features instead of all features and fully grows trees without pruning. Due to the above randomness, the random forest would generate different sets of resulting data in different runs. If users uses predefined benchmark to measure correctness of a random method such as the random forest algorithm or an application involving the method, it becomes difficult to ascertain whether the method/application is good or not.

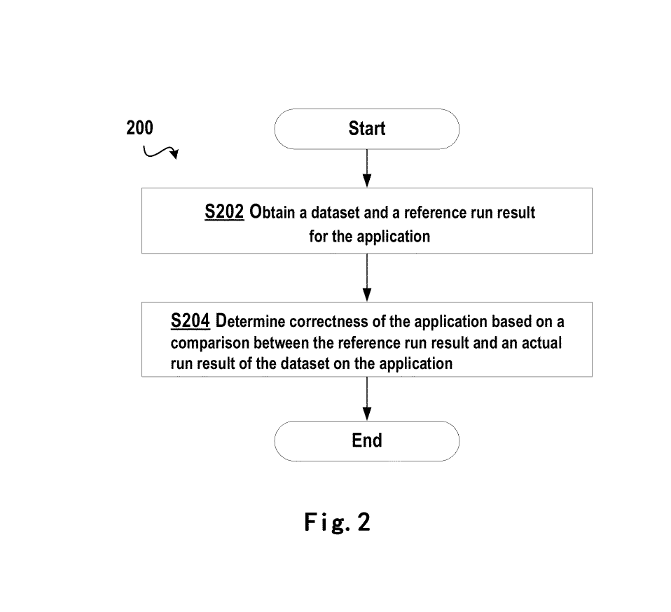

Now with reference to FIG. 2, which shows a flowchart of a method 200 for determining correctness of an application according to an exemplary embodiment of the present invention. After method 200 starts, it first proceeds to step S202 of obtaining a dataset and a reference running result for an application whose correctness is to be determined/ascertained. Those skilled in the art should understand that the term “dataset” here may be various types of datasets, preferably a real dataset from the real world. Such a dataset may be obtained through various channels, for example, downloaded from a public publishing platform or business acquired; and the present disclosure is not limited in this regard. The term “reference running result” refers to a result of running the dataset on another application that is aimed at (solving the) the same problem as this application (i.e. the output of another application when using the dataset as the input). Preferably, the “another application” is an application whose correctness has been proven, i.e. a classic algorithm or application implementation. Likewise, such a reference running result may be obtained through various channels, such as without limitation to being downloaded from a public publishing platform or business acquired or any other means. In addition, it should be noted that preferably the application involved in method 200 may be a randomness-related application, such as an application related to the random forest algorithm, an application related to EM or LDA, etc.

Next method 200 proceeds to step S204 of determining correctness of the application based on a comparison between an actual running result of the dataset on the application and the reference running result. In implementation, the comparison may be outputted in various forms, such as the probabilistic graphical model or neural networks; these models are a generalization of the data. In this case, the difference between the actual running result and the reference running result may be learned more visually and thereby used as an influencing factor for a user to judge correctness of the application. Then method 200 ends.

Note the method for determining correctness of an application according to the present disclosure does not determine correctness with respect to each component module of the application but determines correctness of the application by a data-driven method in the performance respect of data mining tasks, thereby assuring the quality of the application. In this regard, the method for determining correctness of an application according to the present disclosure is performance-oriented.

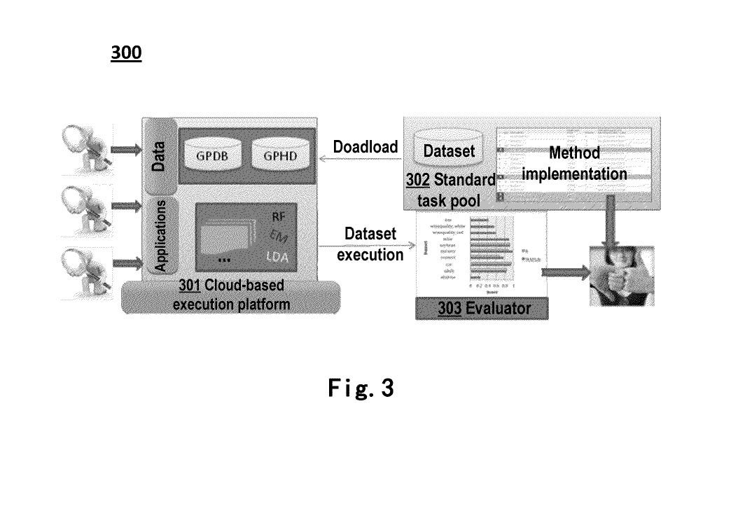

FIG. 3 illustrates a schematic view 300 of a system for determining correctness of an application based on Standard Task Pool according to an exemplary embodiment of the present invention. As shown in FIG. 3, a system 300 comprises: a cloud-based execution platform 301, a standard task pool 302 and an evaluator 303. Standard task pool 302 is a repository including datasets, problem and method (such as without limitation to various algorithms) implementation, and the user may choose from the pool data, problems and methods and download them to cloud-based execution platform 301. Cloud-based execution platform 301 has an application whose correctness is to be determined and a dataset used for the application. These implementations can possibly be the algorithms of Madlib which are based on Greenplum database or the algorithms of Mahout which are based on Hadoop. After obtaining the dataset, cloud-based execution platform 301 executes the dataset on the application whose correctness is to be determined, such as RF, EM, LDA and the like, and obtains an actual execution result. In the meanwhile, one or more proven data mining implementations may be chosen as standard implementations from standard task pool 302 based on the same problem and dataset, and subsequently execution performance of the actual execution result is compared with standard performance. A comparison result (e.g. a comparison report) may be outputted in the form of graphical (e.g. curve, graph, etc.) comparison by the evaluator to the user as one of factors for judging correctness of the application (i.e. quality of the application). The comparison result may possibly relate to a performance result such as accuracy, precision and callback, for further judgment. Optionally, the system may further have a judging module for determining quality of the execution based on a comparison between the execution's performance and standard performance. For example, if the performance of a chosen performance is quite good under some predetermined standards, it may be determined that the application is possibly correct.

Those skilled in the art should understand that execution platform 301 and standard task pool 302 may be built by sampling some existing task pools or platforms such as Kaggle, Weka, RapidMiner, Alpine Miner, UCI machine learning repository etc.

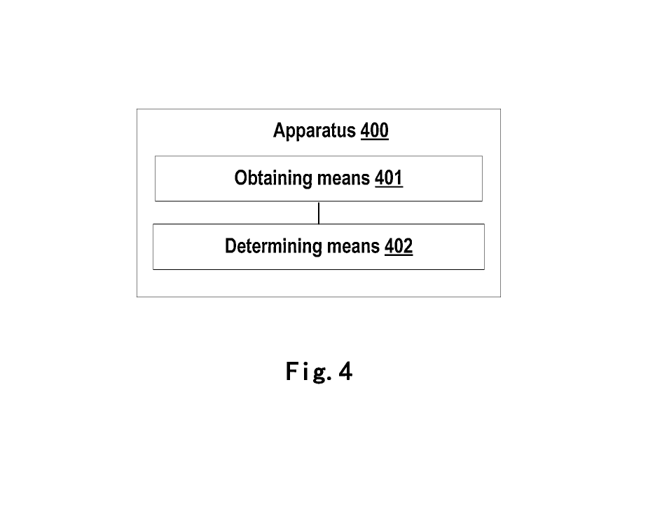

Next with reference to FIG. 4, further description is presented to a system view 400 (also referred to as an apparatus) for determining correctness of an application according to an exemplary embodiment. As shown in FIG. 4, system 400 comprises obtaining means 401 and determining means 402, wherein obtaining means 401 is configured to obtain a dataset and a reference running result for the application; determining means 402 is configured to determine correctness of the application based on a comparison between the reference running result and an actual running result of the dataset on the application.

In an optional embodiment of the present invention, the reference running result comprises a running result of the dataset on another application that is aimed at the same problem as the application. In an optional embodiment of the present invention, the dataset comprises a real dataset. In an optional embodiment of the present invention, the dataset and the reference running result are obtained from a public platform. In an optional embodiment of the present invention, the application comprises a randomness-related application.

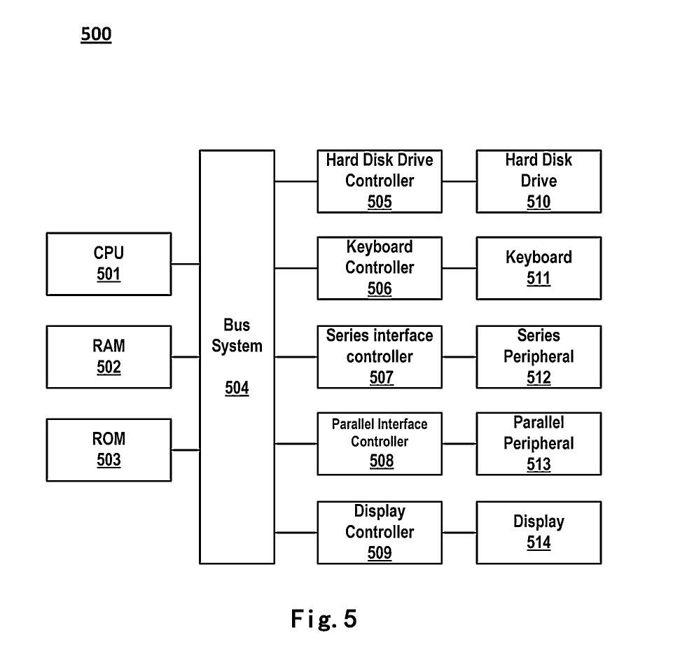

Next with reference to FIG. 5, which shows a schematic block diagram of a computer system 500 that is applicable to implement the embodiments of the present invention. For example, computer system 500 as shown in FIG. 5 may be used for implementing various components of above-described system 300 and apparatus 400 for determining correctness of an application or used for consolidating or implementing various steps of above-described method 200 for determining correctness of an application.

As shown in FIG. 5, the computer system may include: CPU (Central Process Unit) 501, RAM (Random Access Memory) 502, ROM (Read Only Memory) 503, System Bus 504, Hard Drive Controller 505, Keyboard Controller 506, Serial Interface Controller 507, Parallel Interface Controller 508, Display Controller 509, Hard Drive 510, Keyboard 511, Serial Peripheral Equipment 512, Parallel Peripheral Equipment 513 and Display 514. Among above devices, CPU 501, RAM 502, ROM 503, Hard Drive Controller 505, Keyboard Controller 506, Serial Interface Controller 507, Parallel Interface Controller 508 and Display Controller 509 are coupled to the System Bus 504. Hard Drive 510 is coupled to Hard Drive Controller 505. Keyboard 511 is coupled to Keyboard Controller 506. Serial Peripheral Equipment 512 is coupled to Serial Interface Controller 507. Parallel Peripheral Equipment 513 is coupled to Parallel Interface Controller 508. And, Display 514 is coupled to Display Controller 509. It should be understood that the structure as shown in FIG. 5 is only for the exemplary purpose rather than any limitation to the present disclosure. In some cases, some devices may be added to or removed based on specific situations.

As described above, system 300 may be implemented as pure hardware, such as chips, ASIC, SOC, etc. This hardware may be integrated on computer system 500. In addition, the embodiments of the present invention may further be implemented in the form of a computer program product. For example, method 200 that has been described with reference to FIG. 2 may be implemented by a computer program product. The computer program product may be stored in RAM 502, ROM 503, Hard Drive 510 as shown in FIG. 5 and/or any appropriate storage media, or be downloaded to computer system 500 from an appropriate location via a network. The computer program product may include a computer code portion that comprises program instructions executable by an appropriate processing device (e.g., CPU 501 shown in FIG. 5). The program instructions at least may comprise program instructions used for executing the steps of method 200.

The spirit and principles of the present invention have been set forth above in conjunction with several embodiments. The method, system and apparatus for determining correctness of an application according to the present disclosure has several advantages over the prior art. For example, the present disclosure proposes a performance-oriented approach by building up a cloud-based execution environment. Through it, the users can connect to a standard task tool (a library for statistical/analytics algorithms and datasets), thereby proposing a data-driven approach for determining correctness of an application as a complement for the existing quality assurance framework. In addition, the present disclosure saves a lot of work for users to find the test data in real world. It is quite important to use real datasets for determining correctness of an application since only in that way can the application be executed in a fashion that is mostly like the behavior of real users. In addition, the evaluation is performance-oriented in the sense that the metrics required by real users can be directly compared.

It should be noted that the embodiments of the present invention can be implemented in software, hardware or combination of software and hardware. The hardware portion can be implemented by using dedicated logic; the software portion can be stored in a memory and executed by an appropriate instruction executing system such as a microprocessor or dedicated design hardware. Those of ordinary skill in the art may appreciate the above device and method can be implemented by using computer-executable instructions and/or by being contained in processor-controlled code, which is provided on carrier media like a magnetic disk, CD or DVD-ROM, programmable memories like a read-only memory (firmware), or data carriers like an optical or electronic signal carrier. The device and its modules can be embodied as semiconductors like very large scale integrated circuits or gate arrays, logic chips and transistors, or hardware circuitry of programmable hardware devices like field programmable gate arrays and programmable logic devices, or software executable by various types of processors, or a combination of the above hardware circuits and software, such as firmware.

The communication network mentioned in this specification may include various types of network, including without limitation to a local area network (“LAN”), a wide area network (“WAN”), a network according to IP (e.g. Internet), and an end-to-end network (e.g. ad hoc peer-to-peer network).

Note although several means or sub-means of the device have been mentioned in the above detailed description, such division is merely exemplary and not mandatory. In fact, according to the embodiments of the present invention, the features and functions of two or more means described above may be embodied in one means. On the contrary, the features and functions of one means described above may be embodied by a plurality of means.

In addition, although operations of the method of the present invention are described in specific order in the figures, this does not require or suggest these operations be necessarily executed according to the specific order, or all operations be executed before achieving a desired result. On the contrary, the steps depicted in the flowchart may change their execution order. Additionally or alternatively, some steps may be removed, multiple steps may be combined into one step, and/or one step may be decomposed into multiple steps.

Although the present disclosure has been described with reference to several embodiments, it is to be understood the present disclosure is not limited to the embodiments disclosed herein. The present disclosure is intended to embrace various modifications and equivalent arrangements comprised in the spirit and scope of the appended claims. The scope of the appended claims accords with the broadest interpretation, thereby embracing all such modifications and equivalent structures and functions.

What is claimed is:

1. A method for determining correctness of an application, the method comprising:
obtaining a dataset and a reference running result for the application;
comparing the reference running result with an actual result of the dataset; and
from the comparison between the reference running result and the actual verifying correctness of the application.

2. The method as claimed in claim 1, wherein the reference running result comprises a result of the dataset on a pre-determined application.

3. The method as claimed in claim 2, wherein the pre-determined application is expected to address a same problem as addressed by the application.

4. The method as claimed in claim 1, wherein the dataset comprises a real dataset.

5. The method as claimed in claim 1, wherein the dataset and the reference running result are obtained from a public platform.

6. The method as claimed in claim 1, wherein the application comprises a randomness-related application.

7. The method as claimed in claim 1, wherein the comparison is between the reference running result and the actual result is presented as output in visual form.

8. The method as claimed in claim 7, wherein the visual form includes at least one of a graphical form and organized textual form.

9. An apparatus for determining correctness of an application configured to:
obtain a dataset and a reference running result for the application;
compare the reference running result with an actual result of the dataset; and
from the comparison between the reference running result and the actual result verifying correctness of the application.

10. The apparatus as claimed in claim 9, wherein an obtaining means is configured to obtain the dataset and the reference running result.

11. The apparatus as claimed in claim 9, where a determining means is configured to compare the reference running result and the actual result to verify correctness of the application.

12. The apparatus as claimed in claim 9, wherein the reference running result comprises a result of the dataset on a pre-determined application.

13. The apparatus as claimed in claim 12, wherein the pre-determined application is expected to address a same problem as addressed by the application.

14. The apparatus as claimed in claim 9, wherein the dataset comprises a real dataset.

15. The apparatus as claimed in claim 9, wherein the dataset and the reference running result are obtained from a public platform.

16. The apparatus as claimed in claim 9, wherein the application comprises a randomness-related application.

17. The apparatus as claimed in claim 9, wherein the comparison between the reference running result and the actual result in presented as output in visual form.

18. The apparatus as claimed in claim 17, wherein the visual form includes at least one of a graphical form and organized textual form.

19. A computer program product for determining correctness of an application, the computer program product comprising at least one computer-readable storage medium having computer-readable program code portions stored therein, the computer-readable program code portions configured for
obtaining a dataset and a reference running result for the application, wherein the dataset comprises a real dataset and wherein the dataset and the reference running result are obtained from a public platform;
comparing the reference running result with an actual result of the dataset, wherein the reference running result comprises a result of the dataset on a pre-determined application, the pre-determined application is expected to address a same problem as addressed by the application; and
from the comparison between the reference running result and the actual verifying correctness of the application, the comparison is between the reference running result and the actual result is presented as output in visual form, and the visual form includes at least one of a graphical form and organized textual form.

20. The method as claimed in claim 1, wherein the application comprises a randomness-related application.
